(19) United States
(12) Patent Application Publication
(10) Pub. No.: US 2003/0189312 A1
(43) Pub. Date: Oct. 9, 2003

(54) Boat trailer platform device

(76) Inventor: Clayton A. McNamee, Monroe, MI (US)

Correspondence Address: Paul F. Stutz, Ste. 964, 520 Madison Avenue, Toledo, OH, 43604, US

(21) Appl. No.: 10/073,392

(22) Filed: Feb. 12, 2002

(51) Int. Cl. B60P 3/071

(52) U.S. Cl. 280/414.1

(57) ABSTRACT

This invention contemplates a novel dual platform for a boat trailer which features an extremely simple construction of great strength including a pivotal feature fro each of the two platform members allowing greater versatility for the towing vehicle in moving, parking and turning.

### INTRODUCTION

The present invention relates generally to small boats.

More specifically, the present invention relates to the art of launching these small boats, usually in the size range of twelve to twenty-four feet. It is this size boat which is usually trailered to and from and/or between the body of water and the home of the user or between bodies of water etc.

My invention is particularly concerned and is directed to overcoming problems encountered in launching, which include wet feet, shoes, trouser legs, etc. and possibly even injuries frequently encountered and experienced as one launches a small boat of the type concerned.

The launching usually takes place at a public launching facilities consisting of an inclined ramp immediately adjacent a convenient horizontal dock. These can be seen in many parks, be they a city, county or state park or boat ramps privately owned.

Again, the launching procedure usually involves the maneuvering of a towing vehicle in such fashion that it can be backed rearwardly to guide the trailer next to the dock and down the inclined ramp into the water until the boat is floating and available for boating, fishing or what have you.

One unpleasant aspect encountered in the launching of a boat from a trailer is the fact that one person must usually operate the winch located on the tongue of the boat trailer approximate the rear end of the towing vehicle. Usually one person must wade into the water and climb onto the tongue from which position he can handle the winch and continue with the launching operation or reversely operate the winch to pull the boat onto the trailer. There are many and numerous scenarios involved, depending upon the circumstances, the type of boat etc., etc. Invariably, however, the operation involves getting wet feet, boots, pant legs or the like and of course, frequently injuries can occur due to the slipperiness associated with the wetness encountered.

In order to overcome this unpleasantness, as described above; I have designed a novel device/apparatus inclusive of a bracket and a pair of platform members extending laterally from the tongue portion proximate the winch. The bracket of my invention is noted for the universality and adaptability thereof in attaching same to the tongue of almost any conventional boat trailer. The platform members are likewise securely fastened to the bracket and extend laterally on each side so that the one on the platform performing the winching operation can move confidently to the right or the left without getting his feet wet. So that the extending platforms each remain very rigid in the horizontal position.

A further feature of the present invention is that the device can be easily attached and removed and thus imparts a portability factor. On the other hand, my device/apparatus bracket and platform combination can be left more or less permanently attached to the tongue, by reason of a further novel feature of the bracket platform device or apparatus of the present invention as will be revealed in more detail hereinafter.

### PRIOR ART

I am aware of a number of U.S. Patents which are disclosive [symbol] riety of boat trailers including platform systems of one sort or another. These [symbol] ts are:

1.) U.S. Pat. No. 4,943,076 (dated Jul. 24, 1990) issued to one [symbol] dall K. Tripke of Malone, Wis. Device discloses a safety tra [symbol] p to provide improved footing for a person launching or loading a boat onto a trailer. It also discloses the use of a nonskid plate together with an attaching bracket. However the Tripke Patent is primarily devoted to disclosing a bracket that is going to accommodate a variety of sizes of a tongue for boat structure trailer. It does not accomplish the primary purpose of the present inventions as described hereinabove and hereinafter.

2.) Design Pat. No. 371,336 (dated Jul. 2, 1996) issued to Richard A. Wilson of Osage Beach, Mo. This Patent discloses a two-piece self-supporting structure, which embraces a frame member and provides and outwardly extending step for access to the upper cockpit area of the boat and is certainly unlike the present invention.

3.) U.S. Pat. No. 5,228,713 (dated Jul. 20, 1993) issued to one Jere C. Kovach. The boat trailer disclosed in the ‘713’ Patent is adapted to be towed behind a vehicle, but it has both lower and upper boat carrying frames and is consequently quite expensive. It is furthermore complicated and otherwise unable to provide the structurally sound platform of the present invention as illustrated hereinafter.

4.) U.S. Pat. No. 3,984,121 (dated Oct. 5, 1976) and issued to one Dobosi discloses a boat trailer. This structure disclosed in the Dobosi ‘121’ Patent is definitive of a platform 39 facing rearwardly to support an operator who actuates the crank handle causing conjunction with guide members for the boat to be positioned and drawn onto the trailer proper. It is of little value and is not anything like my structure.

5.) U.S. Pat. No. 5,799,961 (dated Sep. 1, 1998) issued to Herald H. Schmeets. This Patent discloses a quickly attachable trailer step featuring two U-shaped mounting brackets. It also features a common central slot to receive a portion of the frame of the trailer and is otherwise nondisclosive of my invention as described hereinafter.

6.) U.S. Pat. No. 4,056,270 (dated Nov. 1, 1977) issued to Kenneth Greenfield. This Patent discloses a detachable boat trailer step featuring a rectangular structure with elongate slots lateral to the tongue and carrying a pair of tightening screws connecting with a bracket member beneath the tongue and rigidly held. At the same time it is capable of sliding movement laterally through the tongue portion of the trailer.

The foregoing Patents, while interesting in their disclosure of a variety of platforms and methods of attaching them to various structures, fail to disclose the combination of elements of my inventive novel and unique bracket/platform combination or the interrelationship of the parts of my invention when assembled into mounted and connected relationship with the tongue portion of a conventional boat trailer.

### OBJECTS OF THE INVENTION

It is accordingly a principal object of the present invention to provide a novel platform apparatus having unique constructional features designed to improve the launching procedure, generally.

It is a further object of my invention to provide such an apparatus which overall makes the launching process more convenient and in particular avoids the wet feet and frequent injuries generally encountered in this operation by reason of the slipperiness associated with the wetness from the lake and on the parts.

It is still another object of the present invention to provide such a platform device, which when attached to the tongue provides a secure and stable platform upon which an individual can stand with safety and confidently, both while operating the winch, during the launching process, and retrieval of the boat into and out of the water.

It is also an object of the present invention that the apparatus provides a safe boat retrieval technique in that one can step from the dock onto the platform when the boat has returned to the dock for loading the boat onto the trailer again through operation of the winch and the line attached.

Further object of the present invention to provide an improved boat trailer platform, which is possessed of a unique combination of properties including simplicity, extreme strength, easily attachable and detachable to the tongue of a conventional boat trailer, provides great stability, includes provisions imparting great steering versatility, permits sharper turns to be traversed due to the fold up nature of both of the principal platform pieces in side by side or end to end relationship can be permanently attached as a design feature of construction, which blends inconspicuously into the overall design of the boat trailer frame etc.

In accordance therewith, it is an object of my present invention to provide a construction which allows the horizontal platform members to pivot upwardly to a angled position in which the platform members do not obstruct or interfere with tight turning and maneuvering of the towing vehicle and the trailer, as such conditions may be met either on the highway or in the pre-launching and post-launching process.

The foregoing, and as well, other objects of the present invention will become apparent to those skilled in the art in the following detailed description taken in conjunction with the attached drawings, which are presented herewith for purposes of illustration only and not limitation.

### DESCRIPTION OF THE DRAWINGS

FIG. 1 is a side elevation view showing a vehicle backing an attached trailer bearing the boat in question rearwardly into the water.

FIG. 2 is a view of the apparatus of the present invention, including all of its component parts being vertically exploded and, in perspective, to illustrate all the parts and the nature of their interrelationship with each other.

FIG. 3 is a sectional view of a conventional trailer tongue securely attached thereto the apparatus/device of the present invention and with platform members extending horizontally to the right and to the left, (dotted outline) and additionally with the platforms pivoted upwardly, as shown (solid line) and connected and held together by a chain in the upper position.

FIG. 4 is a three-quarter perspective view of the platform/apparatus/bracket of the present invention shown in secure attachment with the tongue of a trailer device and desirably located approximately midway between the hitching ball of the towing vehicle and the strut upon which is mounted a winch (not shown).

FIG. 5 is a plan view of a special finger guard protection feature constructed of a piece of metal, which when bent, and attached avoids pinching of the fingers.

FIG. 6 is a perspective view of FIG. 5 folded along the fold lines into the configuration suitable for attachment to the apparatus of the present invention.

### STATEMENT OF INVENTION

In its most simple embodiment the present invention contemplates a novel combination bracket and sturdy platform apparatus composed of readily available off-the-shelf lengths of rigid angle iron, said pieces being strongly secured together without the use of welding, and said angle iron pieces being connected together in a novel manner to provide a dual platform apparatus which provides a stable and secure footing for one launching a boat from a boat trailer using a winch; said platform members being long enough for easy and secure moving the platform to the dock along side the boat after the boat has been deployed into the water.

The present invention also embodies a safety feature consisting of a plurality of specially formed metal guard pieces preventing injury to the one using the device/apparatus of the present invention.

### Specific Disclosure

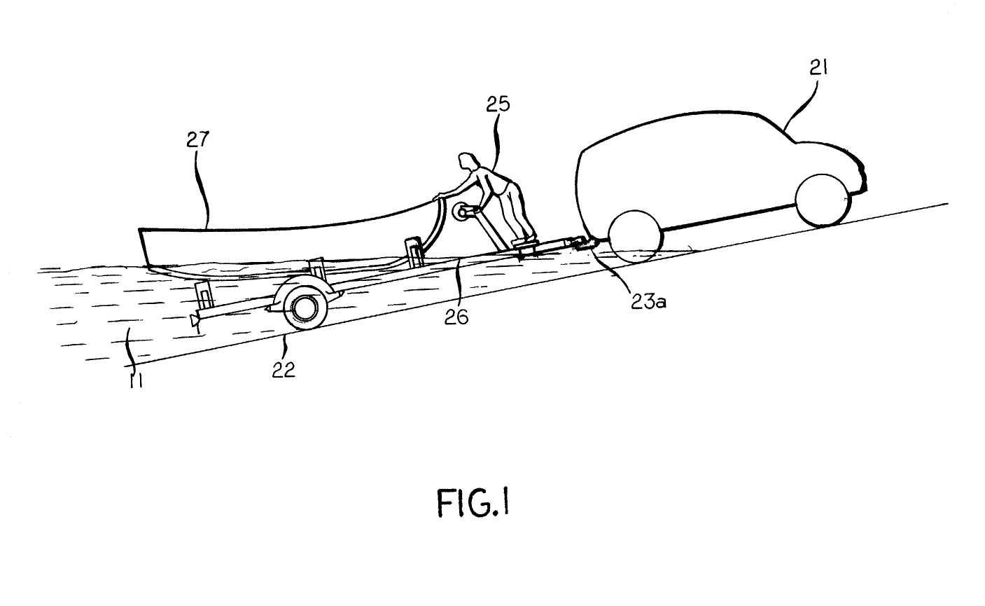

Referring now more specifically to the drawings, there is shown in FIG. 1 an inclined ramp 22, leading into a body of water 11. Situated on the ramp, partially submerged, is a boat trailer 26; upon which is carried a boat 27. An individual 25, is operating a winch 24, to which the bow of the boat 27, is attached by a suitable line (not shown). The individual 25, is urging the boat 27, rearwardly into deeper water sufficient to float the boat. The boat trailer 26, is attached to the vehicle 21, by a conventional ball and socket hitch arrangement 23a.

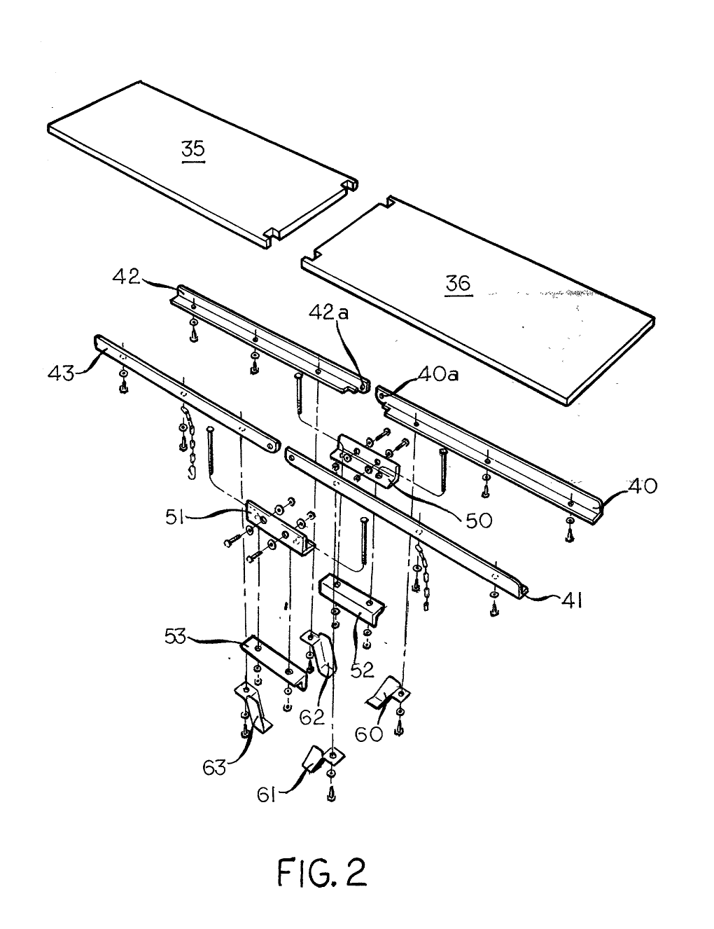

In the interest of clarity and ease of understanding, there is shown in FIG. 2 all of the component parts of the bracket and dual platform device. The parts are shown in vertically, exploded, spaced apart relationship. At the top we see two (2) rectangular platform members 35 and 36. They are about to be lowered onto the four (4) angle iron pieces 40, 41 42 and 43. Two (2) smaller angle iron pieces 50 and 51 are adapted to assume flush abutment with the top of the tongue (not shown). Two (2) similar small angle iron pieces 52 and 53 are adapted to assume flush abutment with the bottom surface of the tongue (not shown). Four machine screws connect the smaller pieces of angle iron pieces together to form the bracket part of the assembly.

Platform 36 is then fastened between angle iron pieces 40 and 41 and secured thereto with the wood screws, as shown. Similarly, platform member 35 is situated on the horizontal flange pieces of angle iron pieces 42 and 43 and secured with wood screws, as shown. The overlapping portions of the large pieces of angle iron and the small pieces of angle iron contribute great strength to the platform members, thus erected. Each of the longer angle iron pieces 40, 41, 42 and 43 have apertures in the ends closest to the other, as shown.

Angle iron pieces 40 and 42 are pivotally secured to short angle iron piece 50 while angle iron pieces 41 and 43 are secured to angle iron piece 51. As noted previously angle iron pieces 50 and 51 are in adjacent flush abutment with the top surface of the tongue.

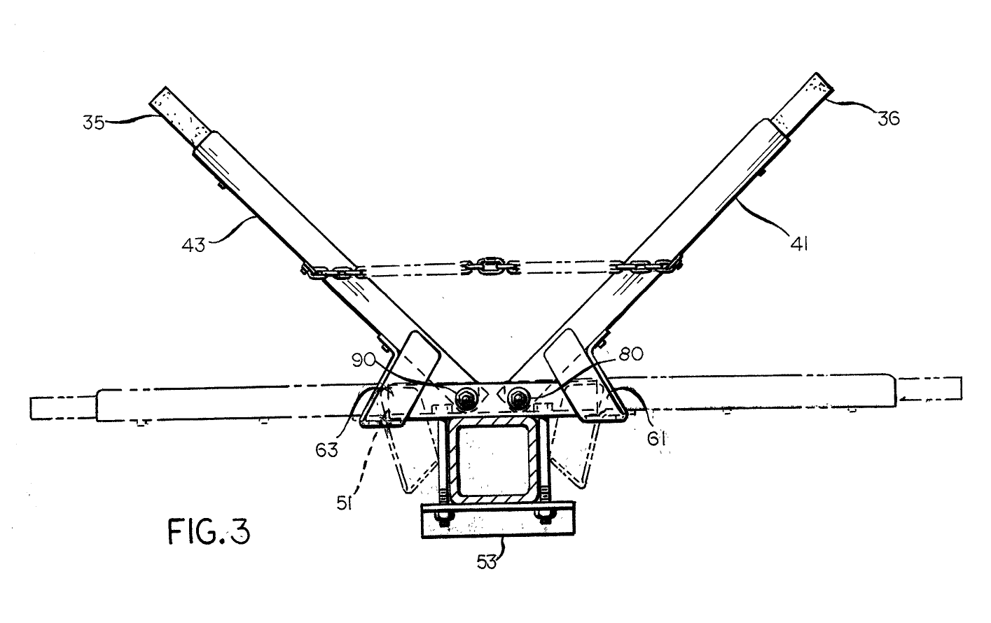

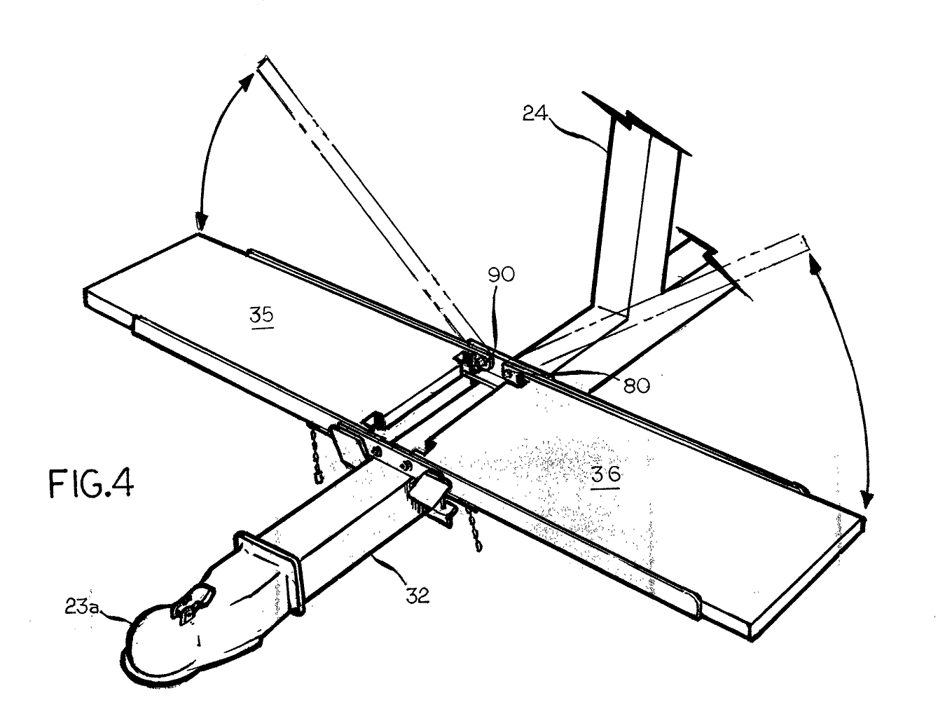

As can be seen with occasional reference to FIGS. 3 and 4 the longer angle iron pieces 40, 41, 42 and 43 are secured snugly and flushly with respect to the upper short angle pieces 50 and 51. In this fashion the platform on the right side formed by the platform piece 36, the longer angle iron piece 40, and the shorter angle iron piece 50 is very rigid and yet pivotal in a manner as will be described. Similarly, the rectangular platform piece 35 and the angle iron pieces 41 and 43 form an extremely rigid structure. This structure of pivotally secured in the manner as just described earlier as to platform piece 35. Great strength is imparted to overall structure by the just described and particularly the overlapping of the ends of the larger pieces with the shorter pieces 50 and 51 bridging and connecting together the terminal apertured ends of the associated angle iron pieces. Finger guard members 60, 61, 62 and 63 are adapted for attachment to the lower horizontal flange portion of the larger angle iron pieces 41 and 43 in the manner shown by the projection lines extending from the respective finger guard members to the apertures in the horizontal bottom flanges of respective four (4) angel iron pieces.

For safety and convenience, the notched end 40a and 42a of the angle iron pieces match the notched end of the platform members in order to allow pivotal movement without any interference of adjoining parts.

The foregoing detailed description shows or discloses the manifest ingenuity and yet, simplicity of the present apparatus which employs conventionally available parts; angle iron, wood, four pieces of aluminum and appropriate nuts and bolts and allows those parts to be assembled into an extended platform permitting boarding of an individual from the dock and conversely from the tongue of the trailer to the dock in a confident manner without fear of falling.

Not every one of the wood screws or bolts for connecting the parts are shown since the drawings are inclusive of projection lines illustrating quite clearly the connection or the fastening of the part together using the apertures as shown and the appropriate pieces for proper securement and mounting to the tongue portion of the trailer.

FIG. 3 is an end elevation view of the apparatus of the present invention secured to the hollow tongue, which is properly shown in section. The solid lines (drawings) show the platforms in the upper position connected by the chain and clasp and in the lower position in the horizontal “use” position (dotted outline).

FIG. 4, like FIG. 3 shows the platform apparatus of the present invention secured to the tongue, but in a perspective view to show a solid outline, the horizontal “use” position of the dual platform device.

A close examination of FIGS. 2, 3 and 4 together shows the very rigid structure together accomplished with a minimum of all “available off the shelf” items.

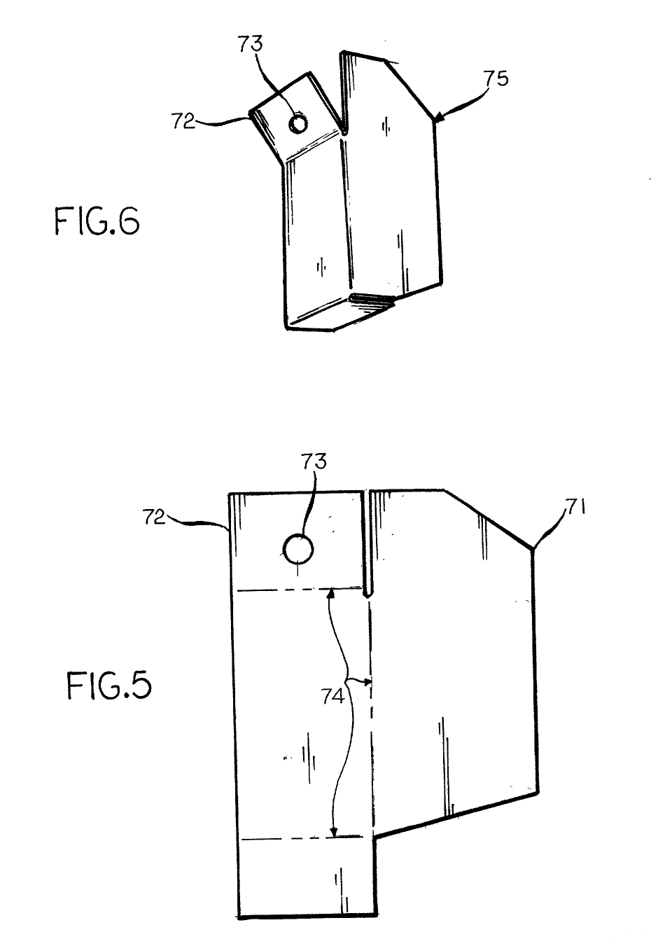

The only irregular pieces of the apparatus of the present invention are the finger guard members 60, 61, 62 and 63. One shown in plan view in FIG. 5 and in folded position in FIG. 6. The finger guard members are conveniently made of aluminum and can be formed easily by a punch press operation to form the irregular shape shown in plan view in FIG. 5 including the aperture 73, and the tab portion 72. Fold lines 74, are shown in dotted outline and provide for convenient bends of the parts to the irregular shape shown in FIG. 6. The tab portion of each part is used to attach the finger guards, as shown in FIG. 2.

For convenience reference may be had to FIG. 3 wherein the finger guards are shown in the down position in dotted outline and in their position guarding against finger damage in the upper position.

Reference to FIG. 3 reveals how easy the bracket can be undone and disengaged from the tongue member. One may initially remove the two (2) platform member assembly by simply loosening and disengaging the machine screws identified by reference numerals 80 and 90 in FIG. 4.

The four smaller angle iron pieces 50, 51, 52 and 53 which together constitute the bracket can be removed by loosening of the appropriate bolts etc.

The reversed procedure can be easily followed in order to attach the bracket and the platform apparatus of the present invention to the tongue of another boat.

In other words, the short angle iron pieces are attached to the tongue in a manner described earlier herein. Then the platform members can be connected by their single aperture pivotal connection to the upper vertical flange portions of the angle iron pieces 50 and 51. A special moment to note that the strength of the angle iron pieces used in this construction are magnified by the overlapping and surface flush abutment relationship of the attached large angle iron members with the upper pair 50 and 51 of the shorter angle iron pieces.

Further, as indicted, the platform device of the present invention is extremely functional and useful in that the novel construction and assembly features allows the tow (2) platform members to be independently folded or pivoted into the position for example shown in FIG. 3 whereby the supplied chain members can be connected together by the clasp, as shown, and thus illustrated in FIG. 3. This feature elevates the platform members out of the way of the body parts of the vehicle, which might otherwise be contacted in a tight turn of the vehicle with the trailer attached, as shown in FIG. 1. This feature is really quite important and desirable in the backing movement, which must be employed in putting the boat trailer into its proper launching position with respect to the ramp and the adjacent dock, as shown in FIG. 1.

The foregoing detailed description shows the manifest ingenuity yet, simplicity of the present aperture/platform/bracket which employs conventionally available parts; angle iron, wood, four pieces of aluminum and appropriate nuts and bolts and allows those parts to be assembled into an extended platform permitting boarding of an individual from the dock and conversely from the tongue of the trailer to the dock in a confident manner without fear of falling.

The apparatus of the present invention utilizes the unique strength of angle iron as a sturdy member, essentially throughout, and the overlapping and bridging feature provided by the use of the shorter angle iron pieces magnifies the strength and stability of the platform portion in its horizontal use position as previously described, this position allows one to stand confidently on the platform attached to the tongue of the trailer being backed into the water by another party to operate the winch and when the boat is launched and the line removed, the individual can walk confidently to the end of the platform, either right or left closest to the dock and step onto the dock, the reverse is also true.

While I have disclosed the principal mode of the present invention consisting of edge facing pivotable platforms employing a novel attachment, universal type attachment for a conventional tongue or for a wide variety of conventional tongues and at the same time providing safety features for the pivoting upward of the platforms from their normal level position to an upper position, I have no intention of being bound to the exact structure shown and to include all such structures as within the scope of the present invention unless to do so would do violence to the CLAIMS appended hereto.

1. A platform apparatus/device adapted to be secured to the elongate tongue member of a conventional boat trailer, said tongue having generally parallel, upper and lower surfaces; said apparatus/device comprising.
first means for securement of said apparatus/device to the tongue portion of a conventional boat trailer; and a pair of spaced, upstanding members adapted for suitable attachment, of said platform members;
and a pair of platform members attached to said spaced upstanding members; said platform members additionally extending laterally and horizontally from said tongue, a distance to provide stable standing room for a person.

2. The invention as claimed in claim 1 wherein said first means comprises attachment means for said platform means which allows pivotal movement of said platform members from their horizontal position to an upwardly inclined position, thereby providing clearance between said platform members and any adjacent object otherwise contacted by said platform members as a result of any movement of said boat and/or trailer.

3) The invention as claimed in claim 2 wherein said tongue and second means comprise four metal angle iron pieces of a length just greater than the width of said tongue member, two of said angle iron pieces being positioned in spaced parallel and flush relationship with the top surface of said tongue member and two of said angle iron pieces being arranged in underlying parallel relationship and in flush abutment with the bottom surface of said tongue; the distal ends of each of said four angle iron pieces being secured together in clamping relationship.

4) The invention as claimed in claim 2, wherein said apparatus/device includes four significantly longer angle iron pieces to which the platform means is attached and being pivotably secured to upper angle iron pieces in flush abutment with the upper surface of said tongue; and means precluding any downward movement of said platform members, whereby they are secured to said angle iron pieces maintained in horizontal relationship of but being free to pivot respectively into an inclined relationship.

5) The invention as claimed in claim 4 wherein the two (2) platform members extending laterally form the tongue are capable of pivoting upwardly to in the neighborhood of forty (40) to sixty (60) degrees, and wherein said apparatus/device includes a means for holding said platform members in their upwardly inclined position.

6) The invention as claimed in claim 5 which includes safety means consisting of irregularly shaped guard pieces secured to each of said board or longer angle iron pieces approximate the angel defined by each platform with a horizontal.
